(19) United States
(12) Patent Application Publication
(10) Pub. No.: US 2024/0332886 A1
(43) Pub. Date: Oct. 3, 2024

(54) SYSTEM AND METHODS FOR A MULTIWAVELENGTH ERBIUM-DOPED FIBER SINGLE RING CAVITY LASER

(71) Applicant: KING FAHD UNIVERSITY OF PETROLEUM AND MINERALS, Dhahran (SA)

(72) Inventors: Khurram Karim QURESHI, Dhahran (SA); Muhammad Jawad MIRZA, Dhahran (SA); Salman Abdul GHAFOOR, Dhahran (SA); Ahmad ATIEH, Dhahran (SA)

(73) Assignee: KING FAHD UNIVERSITY OF PETROLEUM AND MINERALS, Dhahran (SA)

(21) Appl. No.: 18/192,764

(22) Filed: Mar. 30, 2023

(51) Int. Cl. H01S 3/136; G02F 1/21; H01S 3/00; H01S 3/067; H01S 3/16

(52) U.S. Cl. CPC H01S 3/136; G02F 1/212; H01S 3/0064; H01S 3/06791; H01S 3/1608

(57) ABSTRACT

A multiwavelength erbium-doped fiber laser (EDFL) including a single ring cavity, a wave division multiplexer (WDM) coupler, and a pump laser. The pump laser injects a pump laser beam into the single ring cavity. The multiwavelength EDFL includes an erbium doped fiber, an optical isolator (ISO), and a fiber coupler. The erbium doped fiber amplifies the pump laser beam and generates an amplified laser beam. The fiber coupler divides the amplified laser beam into an output laser beam and a laser beam retained in the single ring cavity. The multiwavelength EDFL includes a tunable optical filter (TOF) and an out of cavity comb filter (CF) having a dual-drive Mach-Zehnder modulator (DD-MZM). The TOF receives the laser beam retained in the single ring cavity and filter the retained laser beam to a desired wavelength. The DD-MZM receives the output laser beam and divides the output laser beam into multiple wavelengths.

### STATEMENT REGARDING PRIOR DISCLOSURE BY THE INVENTORS

Aspects of the present disclosure are described in an article “Widely Tunable And Switchable Multiwavelength Erbium-Doped Fiber Laser Based On A Single Ring Cavity” published in the Journal of Optical Society of America B, Vol. 39, Issue 4, pp. 1118-1129 (2022), which is incorporated herein by reference in its entirety.

### BACKGROUND

### Technical Field

The present disclosure is directed to system and methods for a multiwavelength erbium-doped fiber laser (EDFL) including a single ring cavity.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Over the last few years, bandwidth requirements of customers have grown significantly owing to increases in the number of the Internet users and the inclusion of different bandwidth-intensive applications, such as social networking, voice of Internet Protocol (VOIP), video conferences, video streaming, video gaming, e-health, and high-definition television (HDTV). Organizations rely on optical communications-based access networks to address bandwidth demands of customers. Conventionally, dense wavelength-division multiplexing (DWDM) techniques have been deployed by network designers and operators to maximize and/or expand the available bandwidth and data carrying capacity of existing optical communications-based access networks. However, DWDM systems that employ the DWDM techniques are complex and cost-intensive. To overcome these limitations, multiwavelength fiber lasers have been employed in the DWDM systems. Multiwavelength fiber lasers significantly reduce the cost and complexity of the DWDM systems. Moreover, multiwavelength fiber lasers can be easily integrated with optical communications-based access networks. Therefore, multiwavelength fiber lasers have been preferred alternatives to conventional laser sources. The adoption of multiwavelength fiber laser technology has been rapidly growing in a variety of applications such as industrial material processing, medical procedures, remote sensing, scientific instrumentation, microwave photonics, spectroscopy, and optical communication systems.

A conventional L-band erbium-doped fiber laser was described (See: G.-R. Lin et al., “L-band erbium-doped fiber laser with coupling-ratio controlled wavelength tunability,” Opt. Express 14, 9743-9749 (2006), incorporated herein by reference in its entirety) but requires a dual pump, which increases expense and complexity of the system. A multi-wavelength erbium-doped fiber laser based on cascaded filters was described (See: Q. Zhao et al., “Switchable, widely tunable and interval-adjustable multi-wavelength erbium-doped fiber laser based on cascaded filters,” J. Lightwave Technol. 38, 2428-2433 (2020), incorporated herein by reference in its entirety). A wavelength switchable multi-wavelength erbium-doped fiber laser based on polarization dependent loss modulation was described (See: Y. Li et al., “Wavelength switchable multi-wavelength erbium-doped fiber laser based on polarization dependent loss modulation,” J. Lightwave Technol. 39, 243-250 (2021), incorporated herein by reference in its entirety). Q. Zhao et al and Y. Li et al., have cascaded configurations making their setup complex. A multiwavelength erbium-doped random fiber laser was described (See: S. Saleh et al., “Stable multiwavelength erbium-doped random fiber laser,” IEEE J. Sel. Top. Quantum Electron. 24, 0902106 (2017), incorporated herein by reference in its entirety). The laser device setup of Saleh et al., has stability issues. An interval-adjustable multi-wavelength erbium-doped fiber laser was described (See: Q. Zhao et al., “Interval-adjustable multi-wavelength erbium-doped fiber laser with the assistance of NOLM or NALM,” IEEE Access 9, 16316-16322 (2021), incorporated herein by reference in its entirety). The number of wavelengths is about 8, which can be limiting for many applications. A multiwavelength erbium-doped fiber ring laser based on a modified dual-pass Mach-Zehnder interferometer was described (See: A.-P. Luo et al., “Tunable and switchable multiwavelength erbium-doped fiber ring laser based on a modified dual-pass Mach-Zehnder interferometer,” Opt. Lett. 34, 2135-2137 (2009), incorporated herein by reference in its entirety). However, the tuning and wavelength switching is complex. A switchable multi-wavelength erbium-doped fiber laser with an adjustable wavelength interval was described (See: Q. Zhao et al., “Switchable multi-wavelength erbium-doped fiber laser with adjustable wavelength interval,” J. Lightwave Technol. 37, 3784-3790 (2019), incorporated herein by reference in its entirety). An optically controlled tunable ultra-narrow linewidth fiber laser was described (See: L. Huang et al., “Optically controlled tunable ultra-narrow linewidth fiber laser with Rayleigh backscattering and saturable absorption ring,” Opt. Express 26, 26896-26906 (2018), incorporated herein by reference in its entirety). An erbium-doped fiber ring laser based on loop and double-pass EDFA design was described (See: S. A. Sadik et al., “Widely tunable erbium-doped fiber ring laser based on loop and double-pass erbium-doped fiber amplifier design,” Opt. Laser Technol. 124, 105979 (2020), incorporated herein by reference in its entirety). These conventional systems are limited by the number of bandwidths and suffer from various limitations including high cost, inefficiency, and instability.

Accordingly, there is a need for a multiwavelength erbium-doped fiber laser (EDFL) that is efficient, highly stable, and has a low cost.

### SUMMARY

In an exemplary embodiment, a multiwavelength erbium-doped fiber laser (EDFL) is described. The multiwavelength EDFL includes a single ring cavity and a wave division multiplexer (WDM) coupler located within the single ring cavity. The multiwavelength EDFL also includes a pump laser located extra-cavity and connected to the WDM coupler, where the pump laser is configured to inject a pump laser beam into the single ring cavity through the WDM coupler. The multiwavelength EDFL includes an erbium doped fiber located in the single ring cavity, where an input of the erbium doped fiber is connected to the WDM coupler and is configured to amplify the pump laser beam and generate an amplified laser beam. The multiwavelength EDFL includes an optical isolator (ISO) located in the single ring cavity and connected to an output of the erbium doped fiber. The multiwavelength EDFL includes a fiber coupler located in the single ring cavity and connected to the ISO, where the fiber coupler is configured to divide the amplified laser beam into an output laser beam and a laser beam retained in the single ring cavity. The multiwavelength EDFL includes a tunable optical filter (TOF) located within the single ring cavity and connected at a TOF input to the fiber coupler and at a TOF output to an input of the WDM coupler, where the TOF is configured to receive the laser beam retained in the single ring cavity and filter the laser beam retained in the single ring cavity to a desired wavelength, where the desired wavelength is selected from the range of 1524 nm to 1650 nm. The multiwavelength EDFL includes an out of cavity comb filter (CF) connected to the fiber coupler, where the out of cavity CF includes a dual-drive Mach-Zehnder modulator (DD-MZM) configured to receive the output laser beam and divide the output laser beam into multiple wavelengths.

In another exemplary embodiment, a method for generating multiple wavelengths by a single ring cavity EDFL is disclosed. The method includes injecting a pump laser beam into a single ring cavity through a WDM coupler and generating an amplified laser beam by amplifying, with an erbium doped fiber located in the single ring cavity, the pump laser beam. The method includes isolating, with an ISO connected to an output of the erbium doped fiber, the amplified laser beam from back reflections in the single ring cavity. The method includes dividing, by a fiber coupler located in the single ring cavity and connected to the ISO, the amplified laser beam into an output laser beam and a laser beam retained in the single ring cavity. The method includes filtering, with a TOF located within the single ring cavity and connected at a TOF input to the fiber coupler and at a TOF output to the input of the WDM coupler, the retained laser beam to a desired wavelength selected from the range of 1524 nm to 1650 nm. The method includes dividing, by an out of cavity CF connected to the fiber coupler, the output laser beam into multiple wavelengths.

In yet another exemplary embodiment, a method of assembling a multiwavelength EDFL having a single ring cavity is disclosed. The method includes connecting a WDM coupler into the single ring cavity and connecting a pump laser located extra-cavity to the WDM coupler, where the pump laser is configured to inject a pump laser beam into the single ring cavity through the WDM coupler. The method includes connecting an input of an erbium doped fiber to the WDM coupler, where the erbium doped fiber is configured to amplify the pump laser beam and generate an amplified laser beam at an output of the erbium doped fiber, where the erbium doped fiber is configured to have an ion concentration of about 16×10²⁴ ions per meter cubed, and a length of about 5 meters. The method includes connecting an ISO to the output of the erbium doped fiber and connecting a fiber coupler to the ISO, where the fiber coupler is configured to divide the amplified laser beam into an output laser beam and a laser beam retained in the single ring cavity. The method includes connecting an input of a TOF to the fiber coupler and an output of the TOF to the input of the WDM coupler, where the TOF is configured to receive the laser beam retained in the single ring cavity and filter the laser beam retained in the single ring cavity to a desired wavelength selected from the range of 1524 nm to 1650 nm. The method includes connecting an out of cavity CF to the fiber coupler, where the out of cavity CF includes a DD-MZM configured to receive the output laser beam and divide the output laser beam into multiple wavelengths.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A illustrates a schematic representation of a multiwavelength erbium-doped fiber laser (EDFL).

FIG. 1B is an example output of the EDFL.

FIG. 2A depicts a forward pumping configuration of the multiwavelength EDFL.

FIG. 2B depicts a backward pumping configuration of the multiwavelength EDFL.

FIG. 2C depicts a bidirectional pumping configuration of the multiwavelength EDFL.

FIG. 3 shows a graphical plot demonstrating pump power versus lasing power obtained for forward, backward, and bidirectional pumping configurations.

FIG. 4A shows a graphical plot demonstrating pump power versus lasing power obtained for different lengths of an erbium doped fiber in a forward pumping configuration.

FIG. 4B shows a graphical plot demonstrating pump power versus lasing power obtained for different lengths of the erbium doped fiber in a backward pumping configuration.

FIG. 4C shows a graphical plot demonstrating pump power versus lasing power obtained for different lengths of the erbium doped fiber in a bidirectional pumping configuration.

FIG. 5A shows a graphical plot demonstrating lasing wavelength versus lasing power for different output coupling ratios using simulation parameters for the multiwavelength EDFL.

FIG. 5B shows a graphical plot demonstrating lasing wavelength versus lasing power for different output coupling ratios using specifications of a conventional commercial EDFL.

FIG. 6 demonstrates a graphical plot demonstrating pump power versus lasing power for different output coupling ratios.

FIG. 7A shows a spectral plot demonstrating lasing signals input to an out of cavity comb filter (CF) when a tunable optical filter (TOF) is tuned to a wavelength of about 1530 nm.

FIG. 7B shows a spectral plot demonstrating lasing signals input to out of cavity CF when the TOF is tuned to a wavelength of about 1600 nm.

FIG. 8A shows a spectral plot of free spectral range (FSR)-adjustable and switchable multiple wavelengths when the filtered optical signal is centered at 1530 nm and FSR is equal to 25 GHz.

FIG. 8B shows a spectral plot of FSR-adjustable and switchable multiple wavelengths when the filtered optical signal is centered at 1600 nm and FSR is equal to 30 GHz.

FIG. 9 shows a graphical plot of peak lasing power fluctuation obtained for different lasing signals.

FIG. 10 is an illustration of a non-limiting example of details of computing hardware used in the computing system.

FIG. 11 is an exemplary schematic diagram of a data processing system used within the computing system.

FIG. 12 is an exemplary schematic diagram of a processor used with the computing system.

FIG. 13 is an illustration of a non-limiting example of distributed components which may share processing with the controller.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

The term “gain medium” refers to a material that has quantum properties to amplify laser beams through a process of stimulated emission. The gain medium is a source of optical gain within a laser device which results from emission of molecular or electronic transitions from a higher energy state to a lower energy state.

The term “amplified spontaneous emission” (ASE) refers to light produced either by spontaneous emission or light that has been optically amplified by the process of stimulated emission in a gain medium.

Aspects of this disclosure are directed to system and methods for a multiwavelength erbium-doped fiber laser (EDFL) including a single ring cavity.

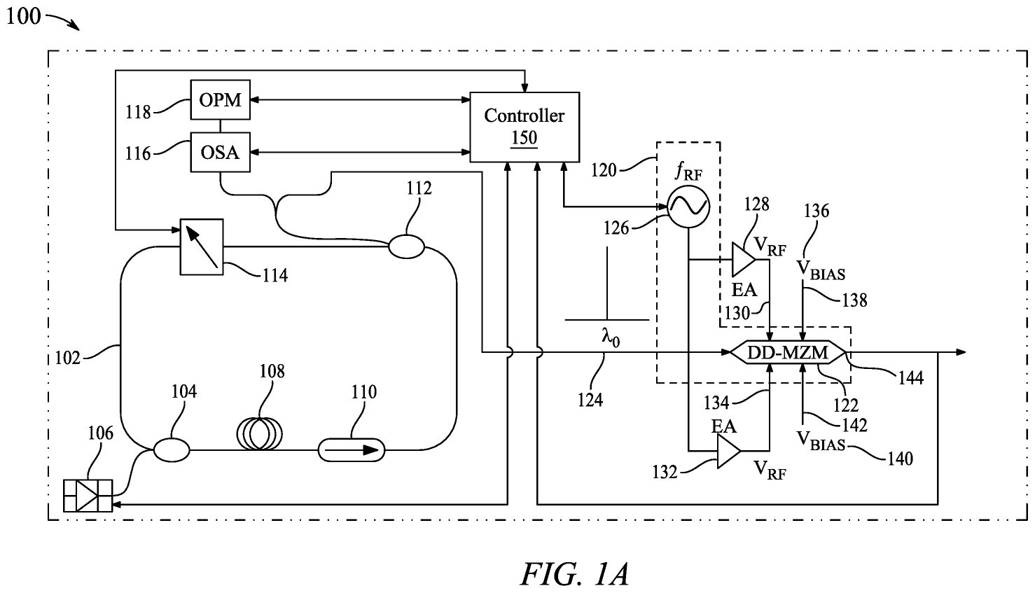

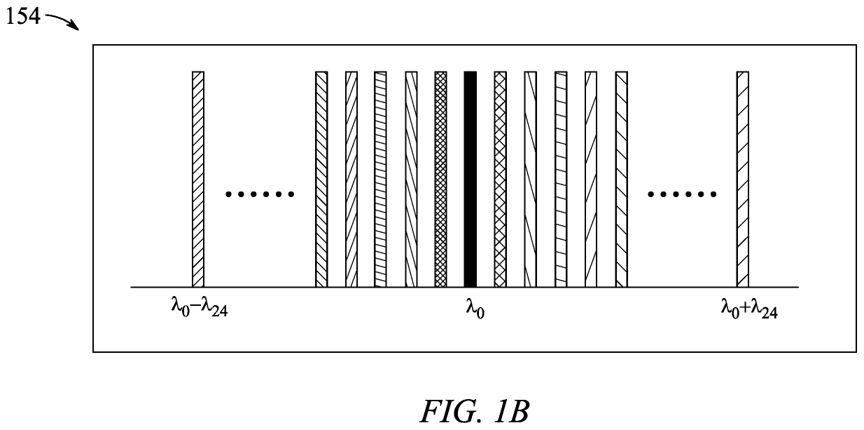

FIG. 1A illustrates a schematic representation of a multiwavelength erbium-doped fiber laser (EDFL) 100.

A rare earth doped fiber optical amplifier is a device that amplifies the optical signal directly, without the need to first convert it to an electrical signal. In the rare earth doped fiber optical amplifier, stimulated emission in the amplifier's gain medium causes amplification of incoming light (optical signal). The rare earth doped fiber optical amplifier amplifies the signal in the optical domain as well as provides a high gain to multiple optical wavelengths simultaneously. In the present disclosure, an erbium doped fiber optical amplifiers is used.

The erbium doped fiber amplifier includes an optical fiber having a core and a doped inner layer. A concentration of erbium ions (Er³⁺) in the doped inner layer is about 16×10²⁴ ions per meter cubed, and a length of the optical fiber is about 5 meters. The multiwavelength EDFL 100 is widely tunable and switchable. The multiwavelength EDFL 100 operates in the 1524 nm to 1650 nm wavelength range covering the C, L, and U bands. The multiwavelength EDFL 100 includes a single ring cavity 102 and a wave division multiplexer (WDM) coupler 104. The WDM coupler 104 is located within (or connected to) the single ring cavity 102. The multiwavelength EDFL 100 also includes a pump laser 106. The pump laser 106 is located outside of the cavity (extra-cavity) and is connected to the WDM coupler 104. The pump laser 106 operates at, for example, about a 980 nm wavelength. The pump laser 106 is configured to generate light at a wavelength of about 980 nm. The multiwavelength EDFL 100 includes an erbium doped fiber 108. The erbium doped fiber 108 is located in the single ring cavity 102. The WDM coupler 104 is connected to an input of the erbium doped fiber 108. The erbium doped fiber 108 has Er³⁺ ion concentration of about 16×10²⁴ ions per meter cubed, and a length of about 5 meters. The pump laser 106 is configured to transfer energy from an external source into a gain medium of the erbium doped fiber 108. The transferred energy is absorbed by the gain medium, producing excited states in its atoms. When the number of particles in one excited state exceeds the number of particles in the ground state or a less-excited state, population inversion is achieved. Population inversion is a process of achieving greater population of higher energy state as compared to the lower energy state. The population inversion causes emission transitions from a laser upper level to a laser lower level. These emission transitions emit photons in an intended wavelength band. Generally, increasing the concentration increases the population inversion leading to high gain and lasing power up to a certain threshold. After this value, the gain and lasing power start decreasing due to clustering effects.

The multiwavelength EDFL 100 includes an optical isolator (ISO) 110 and a fiber coupler 112. The ISO 110 is located in the single ring cavity 102 and is connected to an output of the erbium doped fiber 108. The fiber coupler 112 is also located in the single ring cavity 102 and is connected to the ISO 110. The multiwavelength EDFL 100 includes a tunable optical filter (TOF) 114. The TOF 114 is located within the single ring cavity 102. The TOF 114 is a silica based glass optical fiber having a concentration of erbium ions in a doped inner layer of about 40×10²⁴ ions per meter cubed. The TOF 114 is a transmission type optical bandpass filter (OBPF). The TOF 114 has an insertion loss and a reflection loss of 0 dB and 65 dB, respectively. The fiber coupler 112 is connected to an input of the TOF 114 (also referred to as TOF input) and the WDM coupler 104 is connected to an output of the TOF 114 (also referred to as TOF output). In an aspect, the transmission associated with the TOF 114 is linked with a transfer function of the TOF 114. The transfer function of the TOF 114 is mathematically represented by Equation (1) provided below.

$$T ( f ) = {10}^{- IL / 20} H ( f ) , \qquad ( 1 )$$

where T(f) represents filter transmission, H(f) represents transfer function, and IL represents insertion loss.

The multiwavelength EDFL 100 includes an optical spectrum analyzer (OSA) 116 and an optical power meter (OPM) 118. Both the OSA 116 and the OPM 118 are connected to a first output of the fiber coupler 112. The multiwavelength EDFL 100 also includes an out of cavity comb filter (CF) 120. The out of cavity CF 120 is connected to a second output of the fiber coupler 112. The out of cavity CF 120 is configured to generate multiple wavelengths. The out of cavity CF 120 includes a dual-drive Mach-Zehnder modulator (DD-MZM) 122. The DD-MZM 122 is a device used to determine the relative phase shift variations between two parallel beams derived by splitting light from a single source.

The multiwavelength EDFL 100 includes a first input 124 to the DD-MZM 122 of the out of cavity CF 120 connected to the fiber coupler 112. In the present disclosure, the term “out of cavity” refers to a component which is not located directly in the single ring cavity, but connects to another element located within the single ring cavity. The multiwavelength EDFL 100 includes a frequency variable sinusoidal voltage source 126 (interchangeably referred to as frequency variable voltage source 126). The multiwavelength EDFL 100 includes a first converter amplifier 128 connected between the frequency variable sinusoidal voltage source 126 and a second input 130 to the DD-MZM 122. The multiwavelength EDFL 100 includes a second converter amplifier 132 connected between the frequency variable sinusoidal voltage source 126 and a third input 134 to the DD-MZM 122. Sinusoidal RF voltages are applied to the DD-MZM 122 after amplication by the first converter amplifier 128 and the second converter amplifier 132.

The multiwavelength EDFL 100 also includes a first DC bias voltage source 136 connected to a fourth input 138 to the DD-MZM 122. The first DC bias voltage source 136 is configured to increase the amplitude of an amplified voltage at the second input 130 to the DD-MZM 122. The multiwavelength EDFL 100 includes a second DC bias voltage source 140 connected to a fifth input 142 to the DD-MZM 122. The second DC bias voltage source 140 is configured to increase the amplitude of an amplified voltage at the third input 134 to the DD-MZM 122. The multiwavelength EDFL 100 includes an output port 144 of the DD-MZM 122 configured to generate the multiple wavelengths. In an aspect, the multiple wavelengths are switchable. In an implementation, the DD-MZM 122 is operated in a push-pull mode. The sinusoidal RF voltages applied at the DD-MZM 122 (i.e., at the second input 130 and the third input 134) are opposite in polarity, while the DD-MZM 122 is biased at the quadrature point. The input lasing signal, which is a continuous wave (CW) laser beam generated inside the multiwavelength EDFL 100, is modulated by the sinusoidal RF signal, whose frequency is 25 GHz, with the help of the DD-MZM 122. The amplitude of the sinusoidal RF signal and biasing voltage are tuned in such a way that multiple wavelengths are obtained at the output port 144 of the DD-MZM 122. The multiwavelength EDFL 100 includes a controller 150 communicatively coupled to the pump laser 106, the TOF 114, the OSA 116, the OPM 118, the frequency variable sinusoidal voltage source 126 and output of the DD-MZM 122. The controller 150 controls overrall functioning of the multiwavelength EDFL 100 including initiating the pump laser 106 to generate pump laser beam, tuning the TOF to filter the beam, the OSA 116 to monitor a spectrum of the output laser beam, the OPM 118 to monitor a lasing power of the output laser beam, and the frequency variable sinusoidal voltage source 126 to generate a sinusoidal voltage. The controller 150 also monitors the output of the DD-MZM 122. A user may control the multiwavelength EDFL 100 through interfaces provided in the multiwavelength EDFL 100 (not shown). The controller 110 may be any logic circuitry such as an integrated circuit (IC) that receives (or fetches) instructions from memory (not shown) and processes the instructions and generates output. In examples, the controller 150 may be a microprocessor unit or a microcontroller unit. Some examples of microprocessor unit may include an Intel processor (manufactured by Intel Corporation of Mountain View, California), Advanced Micro Devices processor (manufactured by Advanced Micro Devices of Sunnyvale, California), Snapdragon processor (manufactured by Qualcomm, San Diego, California, United States) and such processors. In examples, the controller 150 may be a customized controller configured for controlling the multiwavelength EDFL 100.

In an example, the multiwavelength EDFL 100 was simulated using an OptiSystem which is an optical communication system design software. The OptiSystem is built by Optiwave System Inc., Ontario, Canada.

The manner in which multiple wavelengths are generated by the multiwavelength EDFL 100 is described in detail below.

According to an aspect of the present disclosure, the controller 150 triggers the pump laser 106 to inject a pump laser beam. The pump laser 106 injects a pump laser beam into the single ring cavity 102 through the WDM coupler 104. The pump laser 106 is configured to generate the pump laser beam at a wavelength of about 980 nm and at a pumped power of about 300 mW. The erbium doped fiber 108 located in the single ring cavity 102 is configured to amplify the pump laser beam and generate an amplified laser beam. The ISO 110 connected to the output of the erbium doped fiber 108 isolates the amplified laser beam from back reflections in the single ring cavity 102. The fiber coupler 112 located in the single ring cavity 102 and connected to the ISO 110 is configured to divide the amplified laser beam into an output laser beam and a laser beam retained in the single ring cavity 102. In an example, the fiber coupler 112 is configured to retain 90% of the laser beam within the single ring cavity 102 and output 10% of the laser beam. The ISO 110 is configured to receive the retained laser beam and ensure unidirectional operation of the multiwavelength EDFL 100 by eliminating back reflections in the single ring cavity 102.

The TOF 114, located within the single ring cavity 102 and connected at the TOF input to the fiber coupler 112 and at the TOF output to the input of the WDM coupler 104, is configured to receive the laser beam retained in the single ring cavity 102 and filter the retained laser beam to a desired wavelength. The TOF 114 is connected to the controller 150 which adjusts its center wavelength to select the desired wavelength. In an example, the desired wavelength is selected from the range of 1524 nm to 1650 nm. In another example, the desired wavelength is selected from the range of 1629 nm to 1650 nm. A TOF is a mass filter which acts as an electronic gate which changes the potential on an accelerator plate to only allow ions to enter the TOF in pulses. When the opening slit has a positive charge, ions will not approach the entryway to a mass analyzer and are retained in an ionization chamber. When all of the previously admitted ions have reached a detector, the polarity on the accelerator(s) is again changed to negative and ions are accelerated toward the slit(s) and into the TOF mass analyzer. As shown in FIG. 1, the TOF 114 is electrically connected to the controller 150 to change the polarity on the accelerator plate.

The OSA 116 connected to an output of the fiber coupler 112 is configured to monitor a spectrum of the output laser beam. The OPM 118 connected to the output of the fiber coupler 112 is configured to monitor a lasing power of the output laser beam. The out of cavity CF 120 connected to the fiber coupler 112 is configured to receive the output laser beam and divide the output laser beam into multiple wavelengths. The out of cavity CF 120 is configured to divide the output laser beam into about 49 wavelengths by varying a frequency of an alternating voltage input to the DD-MZM 122. The 49 wavelengths have average optical power and linewidth of about-10 dBm and about 0.01 nm, respectively.

The DD-MZM 122 is configured to receive the output laser beam and divide the output laser beam into multiple wavelengths. In an example, the multiple wavelengths are selected in the C band range of 1530 nm to 1565 nm. In another example, the multiple wavelengths are selected in the L band range of 1565 nm to 1625 nm. In yet another example, the multiple wavelengths are selected in the U band range of 1625 nm to 1675 nm.

The output laser beam is received at the first input 124 to the DD-MZM 122 of the out of cavity CF 120. The frequency variable sinusoidal voltage source 126 generates a sinusoidal voltage. The first converter amplifier 128 connected to the frequency variable sinusoidal voltage source 126 amplifies the sinusoidal voltage. The sinusoidal voltage is input from the first converter amplifier 128 to the second input 130 to the DD-MZM 122. The second converter amplifier 132 connected to the frequency variable sinusoidal voltage source 126 amplifies the sinusoidal voltage. The sinusoidal voltage is input from the second converter amplifier 132 to the third input 134 to the DD-MZM 122. The fourth input 138 to the DD-MZM 122 receives a first DC bias voltage from the first DC bias voltage source 136. The first DC bias voltage is configured to increase the amplitude of the amplified sinusoidal voltage at the second input 130 to the DD-MZM 122.

The fifth input 142 to the DD-MZM 122 receives a second DC bias voltage from the second DC bias voltage 140. The second DC bias voltage is configured to increase the amplitude of the amplified sinusoidal voltage at the third input 134 to the DD-MZM 122. The multiple wavelengths are generated at the output port 144 of the DD-MZM 122.

According to some implementations, the pump laser 106 generates a broadband amplified spontaneous emission (ASE) signal in the erbium doped fiber 108. The TOF 114 filters the broadband ASE signal and passes the filtered broadband ASE signal again to the erbium doped fiber 108. The selected band of broadband ASE signal is amplified and circulated many times through the TOF 114 and the erbium doped fiber 108. As a result of the process, a continuous wave (CW) laser wavelength is created, which is tapped by the fiber coupler 112 and passed to the DD-MZM 122 to create a comb laser (shown in FIG. 1B with reference numeral 154).

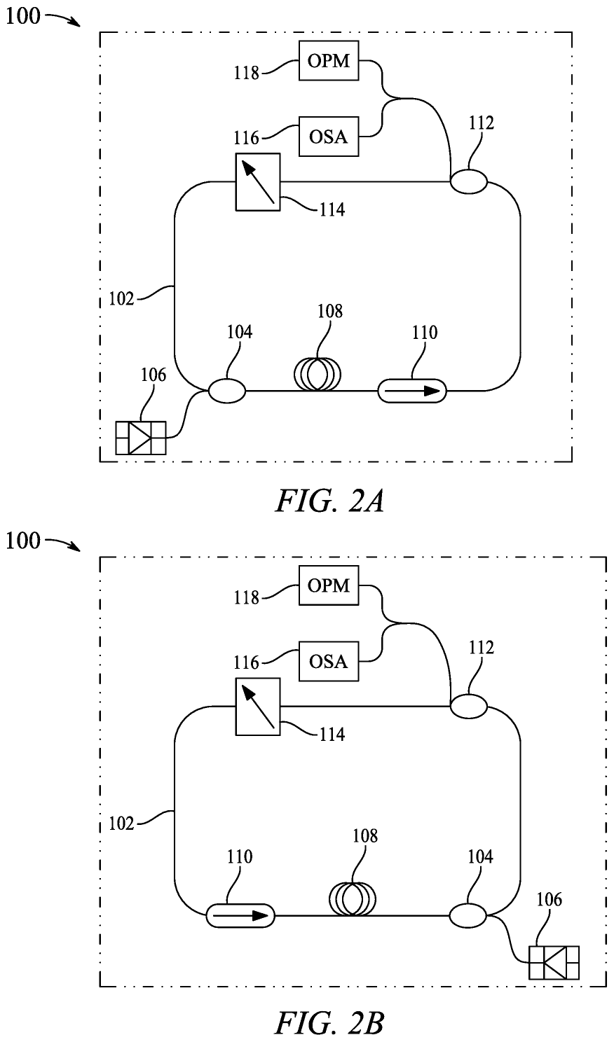

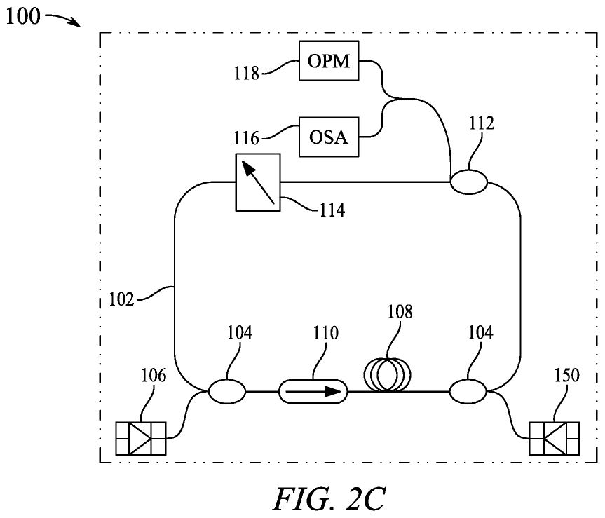

FIG. 2A, FIG. 2B, and FIG. 2C depict the multiwavelength EDFL 100 with different pumping configurations. The different pumping configurations include a forward pumping configuration (FIG. 2A), a backward pumping configuration (FIG. 2B), and a bidirectional pumping configuration (FIG. 2C), In examples, the different pumping configurations are used to excite the Er³⁺ ions.

In particular, FIG. 2A depicts a forward pumping configuration of the multiwavelength EDFL 100. In the example shown in FIG. 2A, the pump and signal co-propagate through the multiwavelength EDFL 100.

FIG. 2B depicts a backward pumping configuration of the multiwavelength EDFL 100. In the example shown in FIG. 2B, the pump and signal counter propagate through the multiwavelength EDFL 100.

FIG. 2C depicts a bidirectional pumping configuration of the multiwavelength EDFL 100. As shown in FIG. 2C, in addition to the pump laser 106, the multiwavelength EDFL 100 includes another pump laser 150. The pump laser 106 and the pump laser 150 are used to pump the gain medium from both ends (bidirectional) of the multiwavelength EDFL 100.

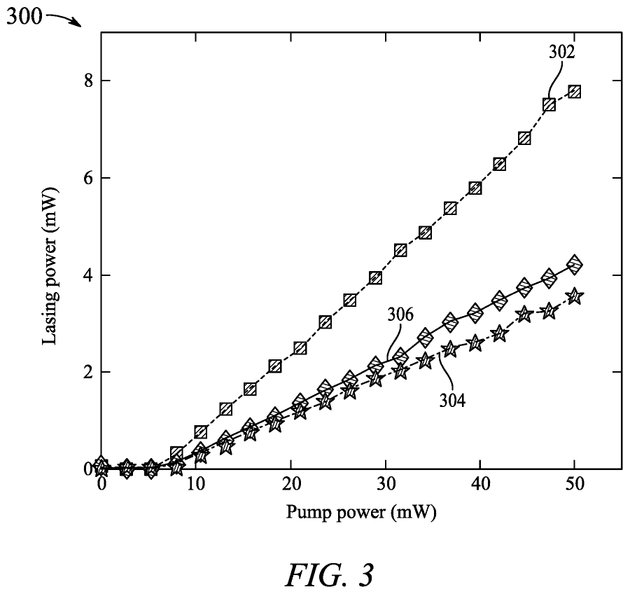

FIG. 3 shows a graphical plot 300 demonstrating pump power versus lasing power obtained for forward, backward, and bidirectional pumping configurations.

In FIG. 3, a plot line 302 depicts pump power versus lasing power obtained for forward pumping configuration, a plot line 304 depicts pump power versus lasing power obtained for bidirectional pumping configuration, and a plot line 306 depicts pump power versus lasing power obtained for backward pumping configuration. It can be observed that the forward pumping configuration yields the highest lasing power for each pump power setting.

The pump power is varied from 0 mW to 50 mW in steps for each pumping configuration. The lasing power is measured by the OPM 118 connected with the fiber coupler 112. Further, the TOF 114 is tuned at 1530 nm. The length of the erbium doped fiber 108 and concentration of Er³⁺ ions are 5 meters and 16×10²⁴ ions per meter cubed, respectively. Further, the parameters of the erbium doped fiber 108, such as active fiber length, effective absorption cross-section of the pump laser beam, effective stimulated emission cross-section of the signal light, and photon energy of the pump laser beam, were kept constant for all three pumping configurations.

It is observed from FIG. 3 that for each pumping configuration, the threshold pump power for lasing is about 5.5 mW. Also, slope efficiency (SE) (linearity) is highest in the forward pumping configuration and lowest in the bidirectional pumping configuration. In FIG. 3, the threshold power is almost similar in all three pumping configurations, as the parameters such as active fiber length, effective absorption cross-section of the pump laser beam, effective stimulated emission cross-section of the signal light, and photon energy of the pump laser beam were kept constant.

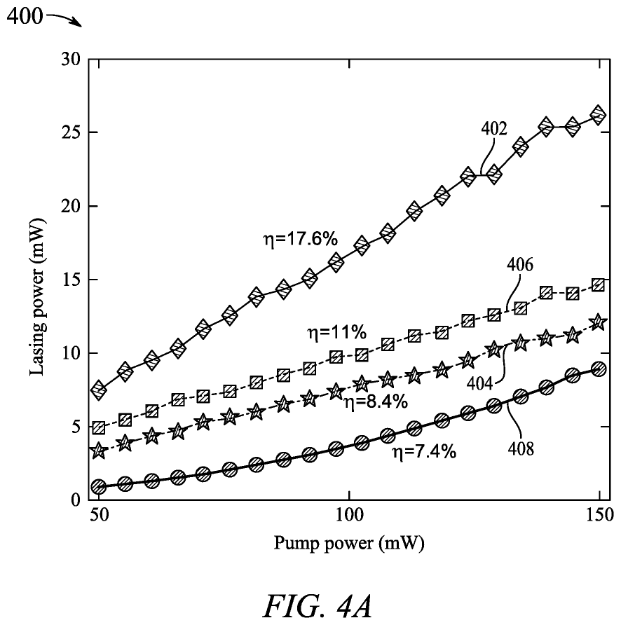

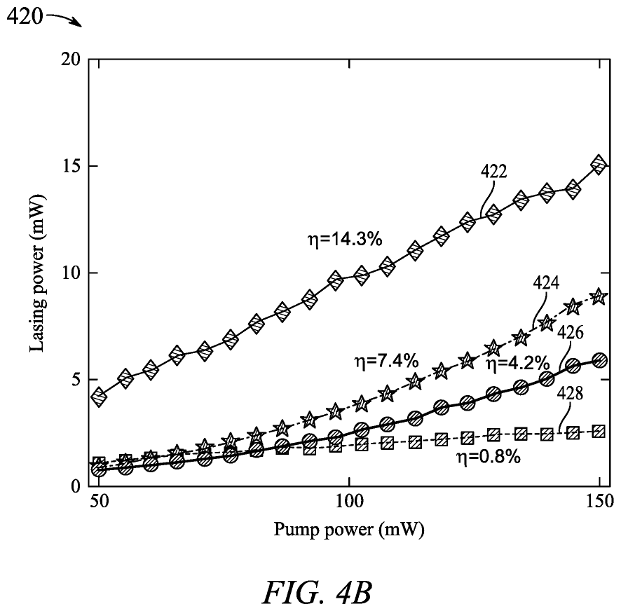

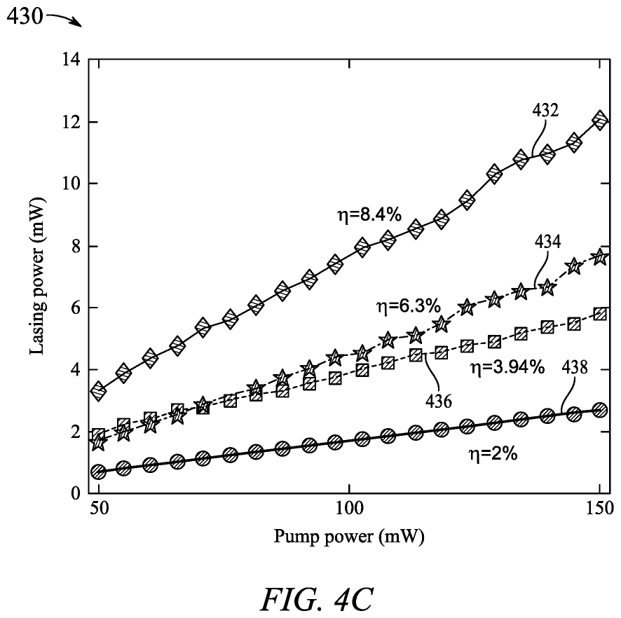

FIG. 4A shows a graphical plot 400 demonstrating pump power versus lasing power obtained for different lengths of the erbium doped fiber 108 in the forward pumping configuration. The pump power is varied from 50 mW to 150 mW in steps for the forward pumping configuration. The lasing power is measured by the OPM 118 connected with the fiber coupler 112. Further, the TOF 114 is tuned at 1530 nm. In FIG. 4A, plot line 402 depicts pump power versus lasing power obtained for erbium doped fiber 108 having a length of about of 5 meters, plot line 404 depicts pump power versus lasing power obtained for erbium doped fiber 108 having a length of about 10 meters, plot line 406 depicts pump power versus lasing power obtained for erbium doped fiber 108 having a length of about 2 meters, and plot line 408 depicts pump power versus lasing power obtained for erbium doped fiber 108 having a length of about 15 meters.

FIG. 4B shows a graphical plot 420 demonstrating pump power versus lasing power obtained for different lengths of the erbium doped fiber 108 in the backward pumping configuration. The pump power is varied from 50 mW to 150 mW in steps for the backward pumping configuration. The lasing power is measured by the OPM 118 connected with the fiber coupler 112. Further, the TOF 114 is tuned at 1530 nm. In FIG. 4B, plot line 422 depicts pump power versus lasing power obtained for erbium doped fiber 108 having a length of about of 5 meters, plot line 424 depicts pump power versus lasing power obtained for erbium doped fiber 108 having a length of about 10 meters, plot line 426 depicts pump power versus lasing power obtained for erbium doped fiber 108 having a length of about 15 meters, and plot line 428 depicts pump power versus lasing power obtained for erbium doped fiber 108 having a length of about 2 meters.

FIG. 4C shows a graphical plot 430 demonstrating pump power versus lasing power obtained for different lengths of the erbium doped fiber 108 and bidirectional pumping configuration. The pump power is varied from 50 mW to 150 mW in steps for the bidirectional pumping configuration. The lasing power is measured by the OPM 118 connected with the fiber coupler 112. Further, the TOF 114 is tuned at 1530 nm. In FIG. 4C, plot line 432 depicts pump power versus lasing power obtained for erbium doped fiber 108 having a length of about of 5 meters, plot line 434 depicts pump power versus lasing power obtained for erbium doped fiber 108 having a length of about 10 meters, plot line 436 depicts pump power versus lasing power obtained for erbium doped fiber 108 having a length of about 2 meters, and plot line 438 depicts pump power versus lasing power obtained for erbium doped fiber 108 having a length of about 15 meters.

It is observed that the SEs (denoted as “n”) equal to 11%, 0.8%, and 3.94% are obtained for forward, backward, and bidirectional pumping configurations, respectively, when the erbium doped fiber 108 has a length of about 2 meters. Further, it is observed that the SEs equal to 17.6%, 14.13%, and 8.4% are obtained for forward, backward, and bidirectional pumping configurations, respectively, when the erbium doped fiber 108 has a length of about 5 meters. This increase in SEs with an increase in the length of the erbium doped fiber 108 may be attributed to an increase in population inversion in the erbium doped fiber 108. Also, it is observed that SEs decrease to 8.4%, 7.4%, and 6.3% for forward, backward, and bidirectional pumping configurations, respectively, when the erbium doped fiber 108 has a length of about 10 meters. Further, SEs become 7.4%, 4.2%, and 2% for forward, backward, and bidirectional pumping configurations, respectively, when the erbium doped fiber 108 has a length of about 15 meters. The reason behind this trend of decreasing the SEs with an increase in the length of the erbium doped fiber 108 is believed to be attributed to a decrease in population inversion in the erbium doped fiber 108, which leads to a decrease in output power. This trend may also be understood by considering that the SE depends upon the length of the erbium doped fiber 108. As observed from FIG. 4A, FIG. 4B, and FIG. 4C, a forward pumping configuration and the erbium doped fiber 108 having a length of about 5 meters are the defined settings for quality performance of the multiwavelength EDFL 100.

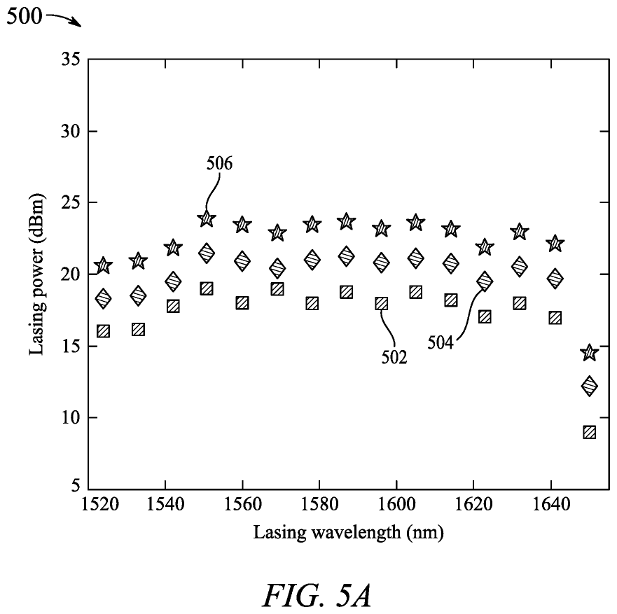

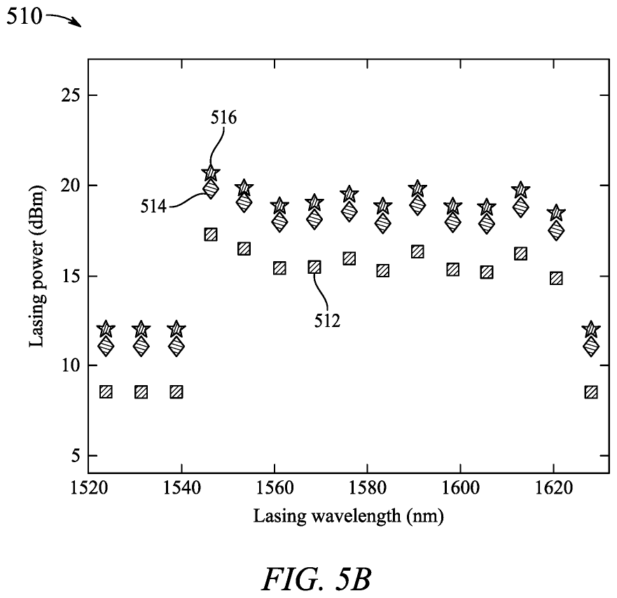

FIG. 5A shows a graphical plot 500 demonstrating lasing wavelength versus lasing power for different output coupling ratios using simulation parameters for the multiwavelength EDFL 100 in OptiSystem. The different output coupling ratios include output coupling ratios of 10%, 20%, and 30%. In FIG. 5A, reference number 502 on the data points represented by stars represents lasing wavelength versus lasing power for output coupling ratio of 10%, reference number 504 on data points represented by diamonds represents lasing wavelength versus lasing power for output coupling ratio of 20%, and reference number 506 on the data points represented by squares represents lasing wavelength versus lasing power for output coupling ratio of 30%.

The simulation parameters are described in Table 1 provided below.

TABLE 1
Simulation Parameters and their values

| Parameter | Value | |
|---|---|---|
| Pump power | 300 | mW |
| Pump wavelength | 980 | nm |
| Er³⁺ ion concentration | 16 × 10²⁴ ions/m³ | |
| Core radius of EDFL | 2.25 | μm |
| Doping radius of EDFL | 1.2 | μm |
| Numerical aperture | 0.26 | |
| Bandwidth of TOF | 0.01 | nm |
| Insertion and return | 0 and 65 dB | |
| losses of TOF | | |
| Resolution bandwidth | 0.01 | nm |
| of OSA | | |
| Metastable level | 10 | ms |
| lifetime | | |
| Absolute temperature | 300 | K |
| Extinction ratio | 30 | dB |
| of DD-MZM | | |
| Gain of electrical | 10 | dB |
| amplifiers | | |

FIG. 5B shows a graphical plot 510 demonstrating lasing wavelength versus lasing power for different output coupling ratios using specifications of a conventional commercial EDFL (Fibercore). The different output coupling ratios include output coupling ratios of 10%, 20%, and 30%. In FIG. 5B, reference number 512 pointing to square boxes represents lasing wavelength versus lasing power for output coupling ratio of 10%, reference number 514 pointing to diamonds represents lasing wavelength versus lasing power for output coupling ratio of 20%, and reference number 516 pointing to stars represents lasing wavelength versus lasing power for output coupling ratio of 30%.

The specifications of a commercial EDFL (Fibercore) are described in Table 2 provided below.

TABLE 2
Specifications of commercial EDFL (Fibercore)

| Parameter | Value |
|---|---|
| Er³⁺ ion concentration | 9 × 10²⁴ ions/m³ |
| Core radius of EDFL | 2.2 μm |
| Doping radius of EDFL | 1.2 μm |
| Numerical aperture | 0.22 |

It is clear from FIG. 5A and FIG. 5B, that the multiwavelength EDFL 100 can be tuned over 126 nm, covering the C-, L-, and U-bands. However, the commercial EDFL (Fibercore) allows tuning over 104 nm, covering the C-, L-, and the edge of the U-band.

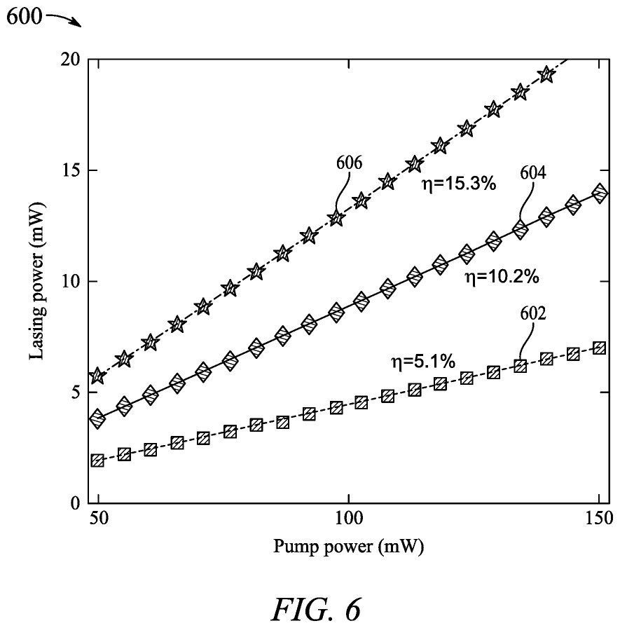

The effect of output coupling ratio on SE of the multiwavelength EDFL 100 is also analyzed. The pump power is varied from 50 mW to 150 mW in steps, and corresponding lasing power is measured when the TOF 114 is tuned at 1600 nm. FIG. 6 demonstrates a graphical plot 600 demonstrating pump power versus lasing power for different output coupling ratios. In FIG. 6, plot line 602 depicts pump power versus lasing power obtained for an output coupling ratio of 10%, plot line 604 depicts pump power versus lasing power obtained for an output coupling ratio of 20%, and plot line 606 depicts pump power versus lasing power obtained for an output coupling ratio of 30%.

It is observed that the SEs (denoted as “n”) equal to 5.1%, 10.2%, and 15.3% are obtained for output coupling ratio of 10%, output coupling ratio of 20%, and output coupling ratio of 30%, respectively. Thus, the highest SE of around 15.3% and lowest SE of around 5.1% are obtained for output coupling ratios of 30% and 10%, respectively. The reason behind this particular trend of increase in SE with increasing value of the output coupling ratio is that the output lasing power increases, which results in an increase in the SE of the multiwavelength EDFL 100.

Further, the TOF 114 is tuned at 1530 nm and the lasing signal at the output of the fiber coupler 112 is given as input to the out of cavity CF 120.

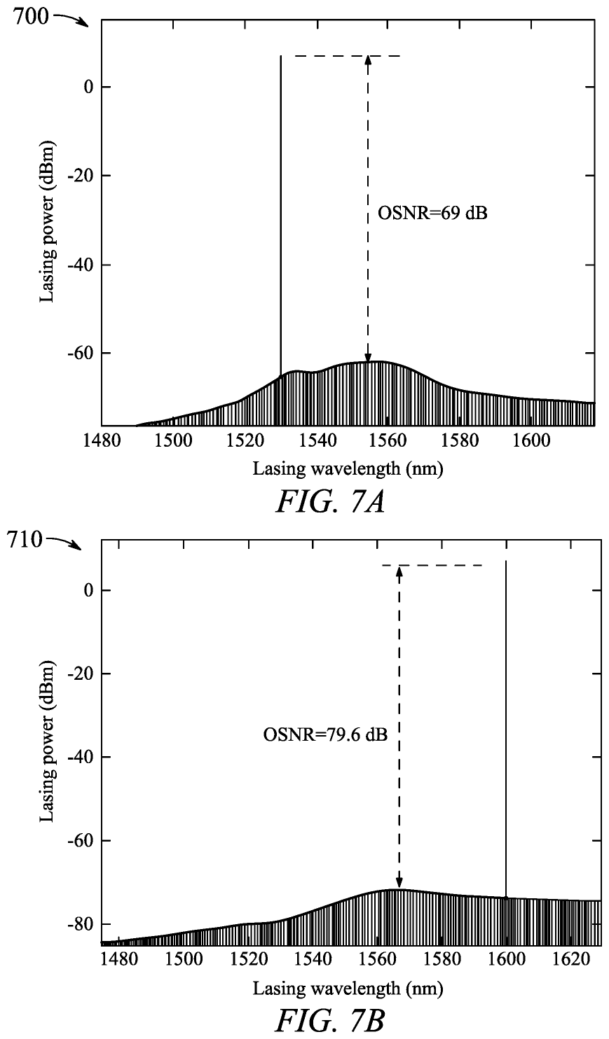

FIG. 7A shows a spectral plot 700 demonstrating lasing signals input to the out of cavity CF 120 when the TOF 114 is tuned at a wavelength of about 1530 nm. As shown in FIG. 7A, when the TOF 114 is tuned at 1530 nm, the optical signal to noise ratio (OSNR) is equal to 69 dB.

FIG. 7B shows a spectral plot 710 demonstrating lasing signals input to the out of cavity CF 120 when the TOF 114 is tuned at a wavelength of about 1600 nm. As shown in FIG. 7B, when the TOF 114 is tuned at 1600 nm, the OSNR is equal to 79.6 dB.

The out-of-cavity CF 120 includes a sinusoidal RF signal and the DD-MZM 122 as shown in FIG. 1. The input lasing signal (i.e., a CW laser) is modulated by the sinusoidal RF signal, whose frequency is 25 GHz, using the DD-MZM 122. The amplitude of sinusoidal RF signal and biasing voltage are tuned in such a way that multiple wavelengths are obtained at the output port 144 of the DD-MZM 122.

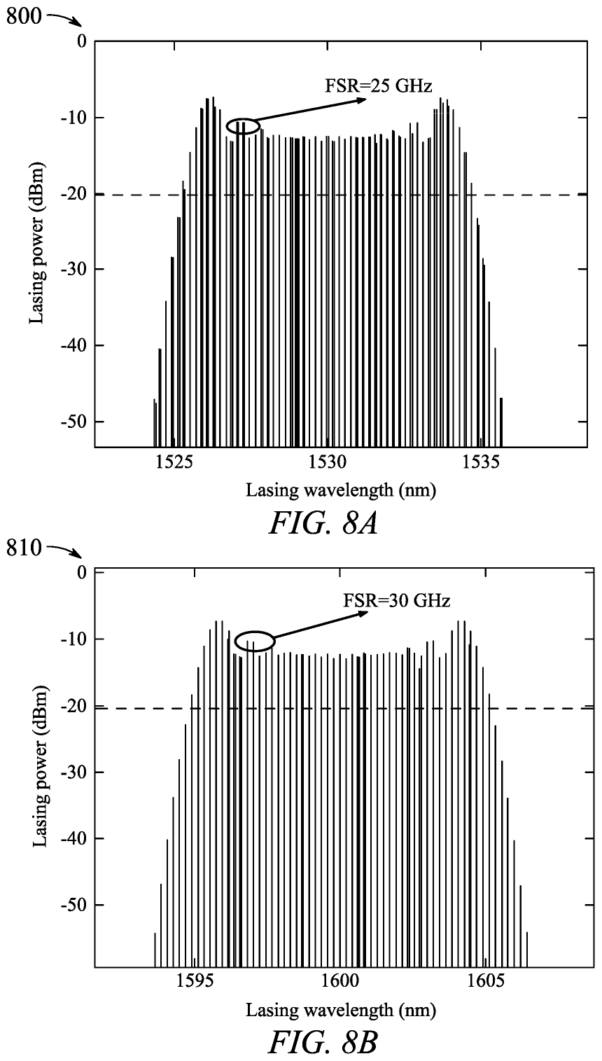

FIG. 8A shows a spectral plot 800 of free spectral range (FSR)-adjustable and switchable multiple wavelengths when the filtered optical signal is centered at 1530 nm (i.e., λ₀=1530 nm) and the FSR is equal to 25 GHz. It is observed from the spectral plot 800 that lasing signal centered at 1530 nm, when given as input to the out of cavity CF 120, results in the generation of 49 wavelengths. These multiple wavelengths are centered around 1530 nm as shown in FIG. 8A. The FSR of the out of cavity CF 120 is the frequency spacing between its transmission peaks. It is observed that all wavelengths are equally spaced at 25 GHz.

FIG. 8B shows a spectral plot 810 of FSR-adjustable and switchable multiple wavelengths when the filtered optical signal is centered at 1600 nm (i.e., λ₀=1600 nm) and the FSR is equal to 30 GHz. It is observed from the spectral plot 810 that lasing signal centered at 1600 nm, when given as input to the out of cavity CF 120, results in the generation of 49 wavelengths. These multiple wavelengths are centered around 1600 nm as shown in FIG. 8B. It is observed that all wavelengths are equally spaced at 30 GHz.

The multiple wavelengths are switched from 1530 to 1600 nm, and the FSR intervals are adjusted from 25 to 30 GHz very easily just by changing the center wavelength of the intracavity TOF and frequency of the sinusoidal RF signal. Moreover, it may be observed from FIG. 8A and FIG. 8B that multiple wavelengths have average optical powers of approximately −10 dBm while exhibiting small power variation among them. Therefore, these wavelengths may be efficiently used in DWDM transmission systems.

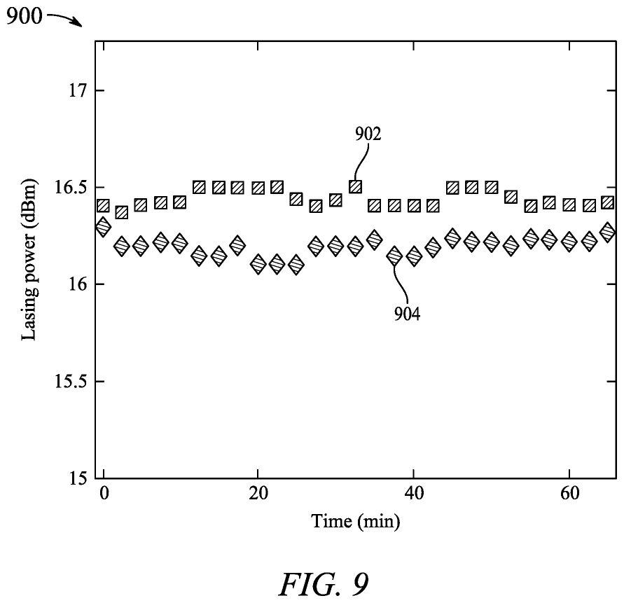

To highlight the stability of the multiwavelength EDFL 100, the peak lasing power fluctuation for lasing signals centered at 1530 nm and 1600 nm for a duration of over 1 hour has been plotted in FIG. 9.

FIG. 9 shows a graphical plot 900 of peak lasing power fluctuation obtained for different lasing signals. In FIG. 9, reference number 902, pointing to the square box data points, represents the peak lasing power fluctuation for lasing signals centered at 1530 nm and reference number 904, pointing to the diamond shaped data points, represents the peak lasing power fluctuation for lasing signals centered at 1600 nm. The peak power fluctuation observed for the lasing signals centered at 1530 nm and 1600 nm is around 0.2 dB over 1 h duration, which shows the stability of the multiwavelength EDFL 100.

The performance of the multiwavelength EDFL 100 of the present disclosure was compared with the aforementioned existing multiwavelength fiber lasers and is summarized in Table 3. It is observed from the Table 3 that the multiwavelength EDFL 100 is efficient in comparison to conventional multiwavelength fiber lasers. The multiwavelength EDFL 100 achieves amplification over a wider band compared to existing multiwavelength fiber lasers.

TABLE 3
Summary of performance comparison

| | EDF | | Ion | Pumps and | Tuning | Number of | Lasing |
|---|---|---|---|---|---|---|---|
| References | Length | | Density | Cavities | Range | Wavelengths | Power |
| G. -R. Lin | 45 | m | — | 2, 1 | 58 nm | 1 | −10 dBm |
| et al. | | | | | (1567- | | |
| | | | | | 1625 nm) | | |
| Q. Zhao | 7 | m | — | 1, 1 | 30 nm | 7 | −10 dBm |
| et al. | | | | | (1530- | | |
| | | | | | 1560 nm) | | |
| Y. Li | 15 | m | 3 × 10²⁴ | 1, 1 | 13 nm | 4 | −40 dBm |
| et al. | | | ions m⁻³ | | (1550- | | |
| | | | | | 1563 nm) | | |
| S. Saleh | 3 | m | — | 1, 1 | 10 nm | 24 | −30 dBm |
| et al. | | | | | (1526- | | |
| | | | | | 1536 nm) | | |
| Q. Zhao | 2 | m | — | 1, 2 | 10 nm | 8 | −27 dBm |
| et al. | | | | | (1556- | | |
| | | | | | 1566 nm) | | |
| A. -P. Luo | 4.5 | m | — | 1, 1 | 20 nm | 29 | −15 dBm |
| et al. | | | | | (1540- | | |
| | | | | | 1560 nm) | | |
| Q. Zhao | 7 | m | — | 1, 2 | 13 nm | 3 | −10 dBm |
| et al. | | | | | (1553.77- | | |
| | | | | | 1567.29 nm) | | |
| L. Huang | 1 | m | — | 3, 2 | 3 nm | 1 | −10 dBm |
| et al. | | | | | (1551- | | |
| | | | | | 1554 nm) | | |
| S. A. Sadik | 6 | m | 2 × 10²⁴ | 2, 1 | 70 nm | 1 | −3 dBm |
| et al. | | | ions m⁻³ | | (1525- | | |
| | | | | | 1595 nm) | | |
| The present | 5 | m | 16 × 10²⁴ | 1, 1 | 126 nm | 49 | −10 dBm |
| multiwavelength | | | ions m⁻³ | | (1524- | | |
| EDFL 100 | | | | | 1650 nm) | | |

By optimizing the length of the erbium doped fiber 108, a wide tunability of 126 nm has been observed with a single ring cavity (for example, the single ring cavity 102 and a single forward pump source (for example, the pump laser 106). The FSR among the multiple wavelengths is adjusted easily by simply varying the frequency of the sinusoidal RF signal used to modulate the lasing signal obtained by tuning the intracavity TOF 114 at a particular wavelength with the help of the DD-MZM 122. The multiwavelength EDFL 100 has low cost, and is efficient and highly stable with an average output power of around 15 dBm for a 10% output coupling ratio over a 126 nm wide tuning range covering C, L, and U bands. The OSNR of each input lasing signal in the C, L, and U bands is higher than 69 dB.

The first embodiment is illustrated with respect to FIGS. 1-9. The first embodiment describes a multiwavelength EDFL 100. The multiwavelength EDFL 100 includes a single ring cavity 102 and a WDM coupler 104 located within the single ring cavity 102. The multiwavelength EDFL 100 also includes a pump laser 106 located extra-cavity and connected to the WDM coupler 104, where the pump laser 106 is configured to inject a pump laser beam into the single ring cavity 102 through the WDM coupler 104. The multiwavelength EDFL 100 includes an erbium doped fiber 108 located in the single ring cavity 102, where an input of the erbium doped fiber 108 is connected to the WDM coupler 104 and is configured to amplify the pump laser beam and generate an amplified laser beam. The multiwavelength EDFL 100 includes an ISO 110 located in the single ring cavity 102 and connected to an output of the erbium doped fiber 108. The multiwavelength EDFL 100 includes a fiber coupler 112 located in the single ring cavity 102 and connected to the ISO 110, where the fiber coupler 112 is configured to divide the amplified laser beam into an output laser beam and a laser beam retained in the single ring cavity 102. The multiwavelength EDFL 100 includes a TOF 114 located within the single ring cavity 102 and connected at a TOF input to the fiber coupler 112 and at a TOF output to an input of the WDM coupler 104, where the TOF 114 is configured to receive the laser beam retained in the single ring cavity 102 and filter the laser beam retained in the single ring cavity 102 to a desired wavelength, where the desired wavelength is selected from the range of 1524 nm to 1650 nm. The multiwavelength EDFL 100 includes an out of cavity CF 120 connected to the fiber coupler 112, where the out of cavity CF 120 includes a DD-MZM 122 configured to receive the output laser beam and divide the output laser beam into multiple wavelengths.

The ISO 110 is configured to receive the retained laser beam and ensure unidirectional operation of the multiwavelength EDFL 100 by eliminating back reflections in the single ring cavity 102.

The fiber coupler 112 is configured to retain 90% of the laser beam within the single ring cavity 102 and output 10% of the laser beam.

The erbium doped fiber 108 has an ion concentration of about 16×10²⁴ ions per meter cubed, and a length of about 5 meters.

The TOF 114 is a transmission type OBPF configured to vary its center wavelength to select the desired wavelength.

The desired wavelength is selected from the range of 1629 nm to 1650 nm.

The multiple wavelengths are selected in the C band range of 1530 nm to 1565 nm.

The multiple wavelengths are selected in the L band range of 1565 nm to 1625 nm.

The multiple wavelengths are selected in the U band range of 1625 nm to 1675 nm.

The pump laser 106 is configured to generate light at a wavelength of about 980 nm.

The out of cavity CF 120 is configured to divide the output laser beam into about 49 wavelengths by varying a frequency of an alternating voltage input to the DD-MZM 122.

The multiwavelength EDFL 100 further includes a first input 124 to the DD-MZM 122 of the out of cavity CF 120 connected to the fiber coupler 112, a frequency variable sinusoidal voltage source 126, a first converter amplifier 128 connected between the frequency variable sinusoidal voltage source 126 and a second input 130 to the DD-MZM 122, a second converter amplifier 132 connected between the frequency variable sinusoidal voltage source 126 and a third input 134 to the DD-MZM 122, and a first DC bias voltage source 136 connected to a fourth input 138 to the DD-MZM 122, where the first DC bias voltage source 136 is configured to increase the amplitude of an amplified voltage at the second input 130 to the DD-MZM 122.

The multiwavelength EDFL 100 also includes a second DC bias voltage source 140 connected to a fifth input 142 to the DD-MZM 122, wherein the second DC bias voltage source 140 is configured to increase the amplitude of an amplified voltage at the third input 134 to the DD-MZM 122 and an output port 144 of the DD-MZM 122 configured to generate the multiple wavelengths.

The multiwavelength EDFL 100 further includes an OSA 116 connected to an output of the fiber coupler 112, where the OSA 116 is configured to monitor a spectrum of the output laser beam.

The multiwavelength EDFL 100 further includes an OPM 118 connected to an output of the fiber coupler 112, where the OPM 118 is configured to monitor a lasing power of the output laser beam.

The second embodiment is illustrated with respect to FIGS. 1-9. The second embodiment describes a method for generating multiple wavelengths by a single ring cavity EDFL 100. The method includes injecting a pump laser beam into a single ring cavity 102 through a WDM coupler 104 and generating an amplified laser beam by amplifying, with an erbium doped fiber 108 located in the single ring cavity 102, the pump laser beam. The method includes isolating, with an ISO 110 connected to an output of the erbium doped fiber 108, the amplified laser beam from back reflections in the single ring cavity 102. The method includes dividing, by a fiber coupler 112 located in the single ring cavity 102 and connected to the ISO 110, the amplified laser beam into an output laser beam and a laser beam retained in the single ring cavity 102. The method includes filtering, with a TOF 114 located within the single ring cavity 102 and connected at a TOF input to the fiber coupler 112 and at a TOF output to the input of the WDM coupler 104, the retained laser beam to a desired wavelength selected from the range of 1524 nm to 1650 nm. The method includes dividing, by an out of cavity CF 120 connected to the fiber coupler 112, the output laser beam into multiple wavelengths.

The method further includes configuring the erbium doped fiber 108 to have an ion concentration of about 16×10²⁴ ions per meter cubed, and a length of about 5 meters.

The method further includes dividing the output laser beam into about 49 wavelengths by varying a frequency of an alternating voltage input to the DD-MZM 122.

The method further includes receiving the output laser beam at a first input 124 to the DD-MZM 122 of the out of cavity CF 120, generating, by a frequency variable voltage source 126, a sinusoidal voltage, amplifying, by a first converter amplifier 128 connected to the frequency variable voltage source 126, the sinusoidal voltage, inputting the sinusoidal voltage from the first converter amplifier 128 to a second input 130 to the DD-MZM 122, amplifying, by a second converter amplifier 132 connected to the frequency variable voltage source 126, the sinusoidal voltage, inputting the sinusoidal voltage from the second converter amplifier 132 to a third input 134 to the DD-MZM 122, and receiving, at a fourth input 138 to the DD-MZM 122, a first DC bias voltage, where the first DC bias voltage is configured to increase the amplitude of the amplified sinusoidal voltage at the second input 130 to the DD-MZM 122.

The method further includes receiving, at a fifth input 142 to the DD-MZM 122, a second DC bias voltage, where the second DC bias voltage is configured to increase the amplitude of the amplified sinusoidal voltage at the third input 134 to the DD-MZM 122, and generating, at an output port 144 of the DD-MZM 122, the multiple wavelengths.

The method further includes monitoring, with an OSA 116 connected to an output of the fiber coupler 112, a spectrum of the output laser beam, and monitor, with an OPM 118 connected to the output of the fiber coupler 112, a lasing power of the output laser beam.

The third embodiment is illustrated with respect to FIGS. 1-9. The third embodiment describes a method of assembling a multiwavelength EDFL 100 having a single ring cavity 102. The method includes connecting a WDM coupler 104 into the single ring cavity 102 and connecting a pump laser 106 located extra-cavity to the WDM coupler 104, where the pump laser 106 is configured to inject a pump laser beam into the single ring cavity 102 through the WDM coupler 104. The method includes connecting an input of an erbium doped fiber 108 to the WDM coupler 104, where the erbium doped fiber 108 is configured to amplify the pump laser beam and generate an amplified laser beam at an output of the erbium doped fiber 108, where the erbium doped fiber 108 is configured to have an ion concentration of about 16×10²⁴ ions per meter cubed, and a length of about 5 meters. The method includes connecting an ISO 110 to the output of the erbium doped fiber 108 and connecting a fiber coupler 112 to the ISO 110, where the fiber coupler 112 is configured to divide the amplified laser beam into an output laser beam and a laser beam retained in the single ring cavity 102. The method includes connecting an input of a TOF 114 to the fiber coupler 112 and an output of the TOF 114 to the input of the WDM coupler 104, where the TOF 114 is configured to receive the laser beam retained in the single ring cavity 102 and filter the laser beam retained in the single ring cavity 102 to a desired wavelength selected from the range of 1524 nm to 1650 nm. The method includes connecting an out of cavity CF 120 to the fiber coupler 112, where the out of cavity CF 120 includes a DD-MZM 122 configured to receive the output laser beam and divide the output laser beam into multiple wavelengths.

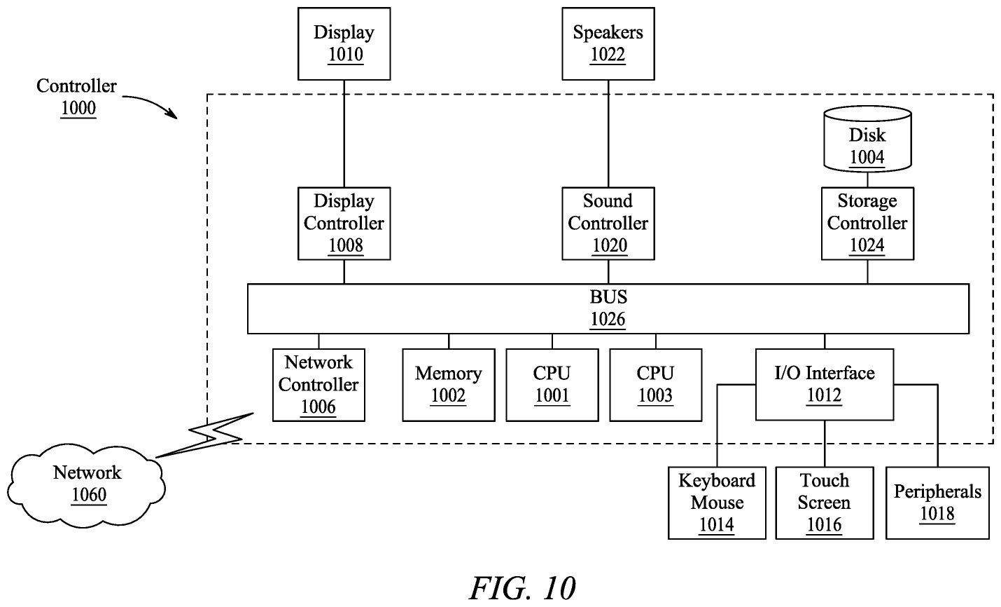

Next, further details of the hardware description of the computing environment according to exemplary embodiments is described with reference to FIG. 10. FIG. 10 is an illustration of a non-limiting example of details of computing hardware used in the computing system, according to exemplary aspects of the present disclosure. In FIG. 10, a controller 1000 is described which is a computing device (for example, the controller 150) and includes a CPU 1001 which performs the processes described above/below. The process data and instructions may be stored in memory 1002. These processes and instructions may also be stored on a storage medium disk 1004 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 1001, 1003 and an operating system such as Microsoft Windows 7, Microsoft Windows 10, Microsoft Windows 11, UNIX, Solaris, LINUX, Apple MAC-OS and other systems known to those skilled in the art.

The hardware elements in order to achieve the computing device may be realized by various circuitry elements, known to those skilled in the art. For example, CPU 1001 or CPU 1003 may be a Xenon or Core processor from Intel of America or an Opteron processor from AMD of America, or may be other processor types that would be recognized by one of ordinary skill in the art. Alternatively, the CPU 1001, 1003 may be implemented on an FPGA, ASIC, PLD or using discrete logic circuits, as one of ordinary skill in the art would recognize. Further, CPU 1001, 1003 may be implemented as multiple processors cooperatively working in parallel to perform the instructions of the inventive processes described above.

The computing device in FIG. 10 also includes a network controller 1006, such as an Intel Ethernet PRO network interface card from Intel Corporation of America, for interfacing with network 1060. As can be appreciated, the network 1060 can be a public network, such as the Internet, or a private network such as an LAN or WAN network, or any combination thereof and can also include PSTN or ISDN sub-networks. The network 1060 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 1008, such as a NVIDIA GeForce GTX or Quadro graphics adaptor from NVIDIA Corporation of America for interfacing with display 1010, such as a Hewlett Packard HPL2445w LCD monitor. A general purpose I/O interface 1012 interfaces with a keyboard and/or mouse 1014 as well as a touch screen panel 1016 on or separate from display 1010. General purpose I/O interface also connects to a variety of peripherals 1018 including printers and scanners, such as an OfficeJet or DeskJet from Hewlett Packard.

A sound controller 1020 is also provided in the computing device such as Sound Blaster X-Fi Titanium from Creative, to interface with speakers/microphone 1022 thereby providing sounds and/or music. The general purpose storage controller 1024 connects the storage medium disk 1004 with communication bus 1026, which may be an ISA, EISA, VESA, PCI, or similar, for interconnecting all of the components of the computing device. A description of the general features and functionality of the display 1010, keyboard and/or mouse 1014, as well as the display controller 1008, storage controller 1024, network controller 1006, sound controller 1020, and general purpose I/O interface 1012 is omitted herein for brevity as these features are known.

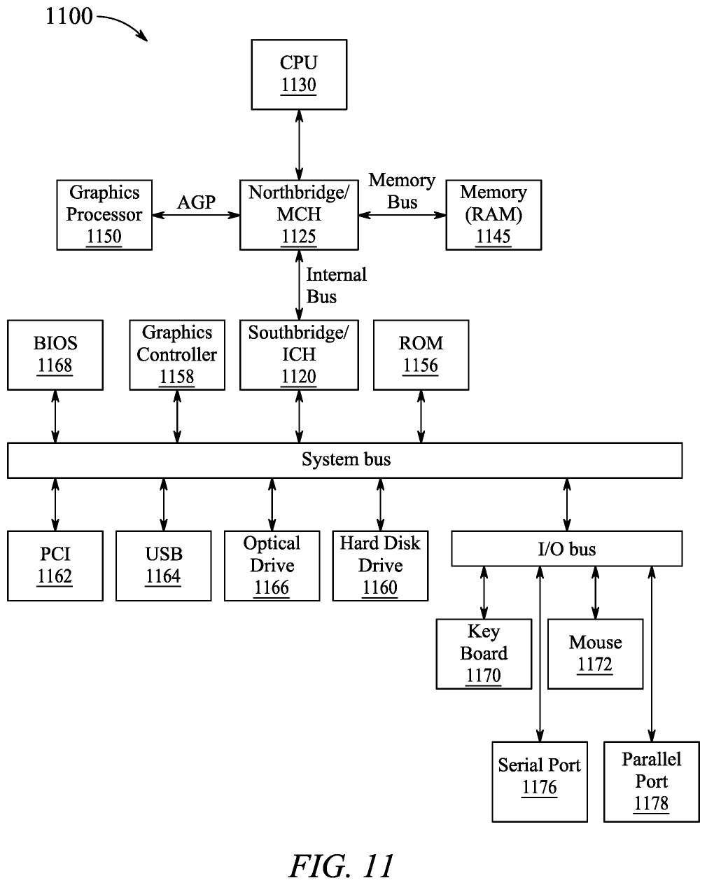

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 11.

FIG. 11 shows a schematic diagram of a data processing system 1100 for performing the functions of the exemplary embodiments. The data processing system 1100 is an example of a computer in which code or instructions implementing the processes of the illustrative embodiments may be located.

In FIG. 11, data processing system 1100 employs a hub architecture including a north bridge and memory controller hub (NB/MCH) 1125 and a south bridge and input/output (I/O) controller hub (SB/ICH) 1120. The central processing unit (CPU) 1130 is connected to NB/MCH 1125. The NB/MCH 1125 also connects to the memory 1145 via a memory bus, and connects to the graphics processor 1150 via an accelerated graphics port (AGP). The NB/MCH 1125 also connects to the SB/ICH 1120 via an internal bus (e.g., a unified media interface or a direct media interface). The CPU Processing unit 1130 may contain one or more processors and even may be implemented using one or more heterogeneous processor systems.

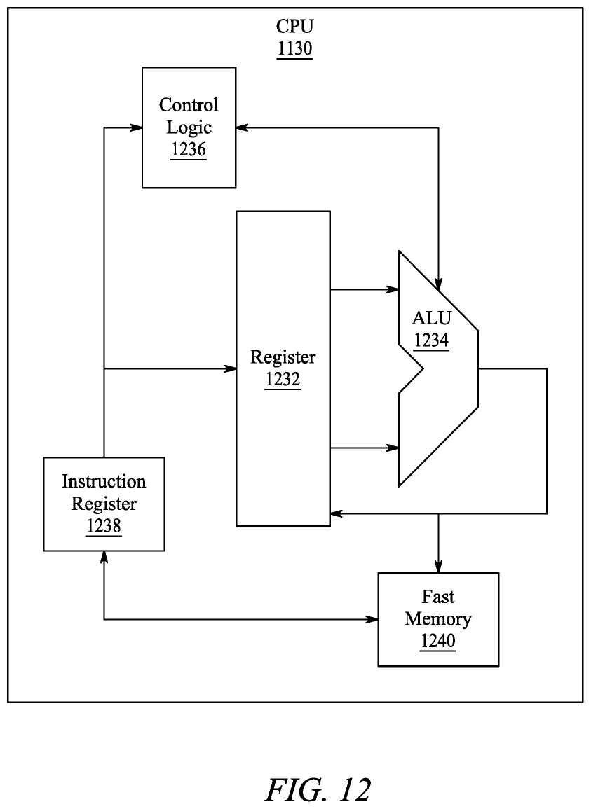

For example, FIG. 12 shows one implementation of CPU 1130. In one implementation, the instruction register 1238 retrieves instructions from the fast memory 1240. At least part of these instructions are fetched from the instruction register 1238 by the control logic 1236 and interpreted according to the instruction set architecture of the CPU 1230. Part of the instructions can also be directed to the register 1232. In one implementation, the instructions are decoded according to a hardwired method, and in another implementation, the instructions are decoded according to a microprogram that translates instructions into sets of CPU configuration signals that are applied sequentially over multiple clock pulses. After fetching and decoding the instructions, the instructions are executed using the arithmetic logic unit (ALU) 1234 that loads values from the register 1232 and performs logical and mathematical operations on the loaded values according to the instructions. The results from these operations can be feedback into the register and/or stored in the fast memory 1240. According to certain implementations, the instruction set architecture of the CPU 1130 can use a reduced instruction set architecture, a complex instruction set architecture, a vector processor architecture, a very large instruction word architecture. Furthermore, the CPU 1230 can be based on the Von Neuman model or the Harvard model. The CPU 1230 can be a digital signal processor, an FPGA, an ASIC, a PLA, a PLD, or a CPLD. Further, the CPU 1130 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 11, the data processing system 1100 can include that the SB/ICH 1120 is coupled through a system bus to an I/O Bus, a read only memory (ROM) 1156, universal serial bus (USB) port 1164, a flash binary input/output system (BIOS) 1168, and a graphics controller 1158. PCI/PCIe devices can also be coupled to SB/ICH 1120 through a PCI bus 1162.

The PCI devices may include, for example, Ethernet adapters, add-in cards, and PC cards for notebook computers. The Hard disk drive 1160 and CD-ROM 1156 can use, for example, an integrated drive electronics (IDE) or serial advanced technology attachment (SATA) interface. In one implementation, the I/O bus can include a super I/O (SIO) device.

Further, the hard disk drive (HDD) 1160 and optical drive 1166 can also be coupled to the SB/ICH 1120 through a system bus. In one implementation, a keyboard 1170, a mouse 1172, a parallel port 1178, and a serial port 1176 can be connected to the system bus through the I/O bus. Other peripherals and devices that can be connected to the SB/ICH 1120 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

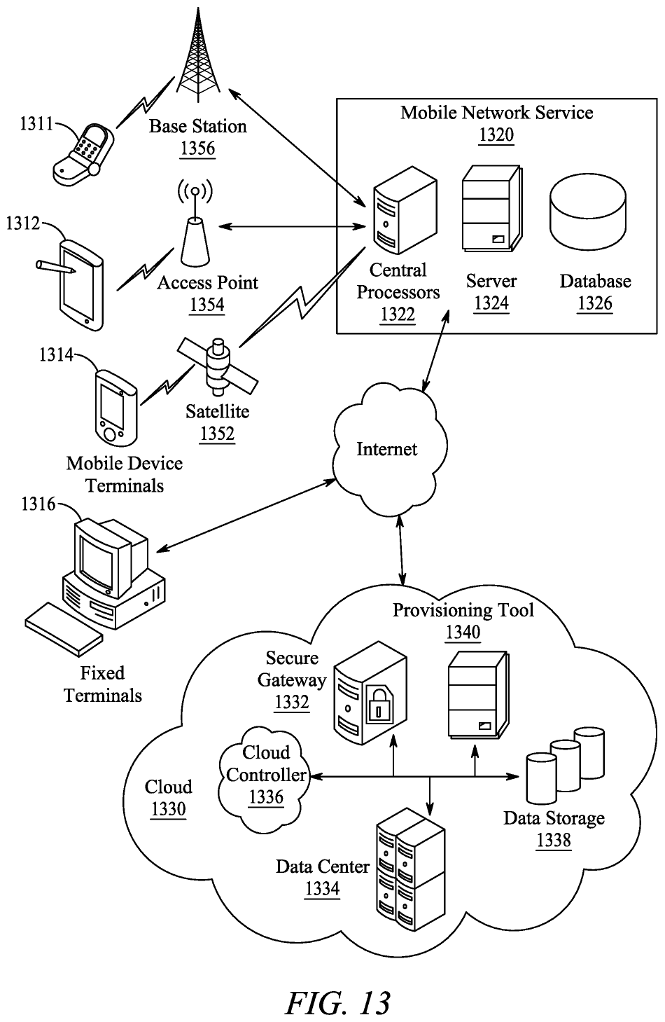

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 13, in addition to various human interface and communication devices (e.g., display monitors, smart phones, tablets, personal digital assistants (PDAs)).

More specifically, FIG. 13 illustrates client devices including a smart phone 1311, a tablet 1312, a mobile device terminal 1314 and fixed terminals 1316. These client devices may be commutatively coupled with a mobile network service 1320 via base station 1356, access point 1354, satellite 1352 or via an internet connection. Mobile network service 1320 may comprise central processors 1322, a server 1324 and a database 1326. Fixed terminals 1316 and mobile network service 1320 may be commutatively coupled via an internet connection to functions in cloud 1330 that may comprise security gateway 1332, data center 1334, cloud controller 1336, data storage 1338 and provisioning tool 1340. The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A multiwavelength erbium-doped fiber laser (EDFL), comprising:
a single ring cavity;
a wave division multiplexer (WDM) coupler located within the single ring cavity;
a pump laser located outside of the single ring cavity and optically connected to the WDM coupler, wherein the pump laser is configured to inject a pump laser beam into the single ring cavity through the WDM coupler;
an erbium doped fiber located in the single ring cavity, wherein an input terminal of the erbium doped fiber is connected to the WDM coupler and is configured to amplify the pump laser beam and generate an amplified laser beam by stimulated emission of the erbium doped fiber;
an optical isolator (ISO) located in the single ring cavity and connected to an output terminal of the erbium doped fiber;
a fiber coupler located in the single ring cavity and connected to the ISO, wherein the fiber coupler is configured to divide the amplified laser beam into an output laser beam and a laser beam retained in the single ring cavity;
a tunable optical filter (TOF) located within the single ring cavity and connected at a TOF input terminal to the fiber coupler and at a TOF output terminal to an input terminal of the WDM coupler, wherein the TOF is configured to receive the laser beam retained in the single ring cavity and filter the laser beam retained in the single ring cavity to a desired wavelength, wherein the desired wavelength is selected from the range of 1524 nm to 1650 nm; and
a comb filter (CF) connected to the fiber coupler, wherein the CF includes a dual-drive Mach-Zehnder modulator (DD-MZM) configured to receive the output laser beam and divide the output laser beam into multiple wavelengths.

2. The multiwavelength EDFL of claim 1, wherein the ISO is configured to receive the retained laser beam and ensure unidirectional operation of the retained laser beam by eliminating back reflections in the single ring cavity.

3. The multiwavelength EDFL of claim 1, wherein the fiber coupler is configured to retain 90% of the laser beam within the single ring cavity and output 10% of the laser beam.

4. The multiwavelength EDFL of claim 1, wherein the erbium doped fiber has an Er³⁺ ion concentration of about 16×10²⁴ ions per meter cubed, and a length of about 5 meters.

5. The multiwavelength EDFL of claim 1, further comprising a controller connected to the TOF, the pump laser, the OSA, the OPM, and the comb filter.

6. The multiwavelength EDFL of claim 4, wherein the desired wavelength is selected from the range of 1629 nm to 1650 nm.

7. The multiwavelength EDFL of claim 4, wherein the multiple wavelengths are selected in the C band range of 1530 nm to 1565 nm.

8. The multiwavelength EDFL of claim 4, wherein the multiple wavelengths are selected in the L band range of 1565 nm to 1625 nm.

9. The multiwavelength EDFL of claim 4, wherein the multiple wavelengths are selected in the U band range of 1625 nm to 1675 nm.

10. The multiwavelength EDFL of claim 1, wherein the pump laser is configured to generate light at a wavelength of about 980 nm.

11. The multiwavelength EDFL of claim 1, wherein the out of cavity CF is configured to divide the output laser beam into about 49 wavelengths by varying a frequency of an alternating voltage input to the DD-MZM.

12. The multiwavelength EDFL of claim 1, further comprising:
a first input to the DD-MZM of the out of cavity CF connected to the fiber coupler;
a frequency variable sinusoidal voltage source;
a first converter amplifier connected between the frequency variable sinusoidal voltage source and a second input to the DD-MZM;
a second converter amplifier connected between the frequency variable sinusoidal voltage source and a third input to the DD-MZM;
a first DC bias voltage source connected to a fourth input to the DD-MZM, wherein the first DC bias voltage source is configured to increase the amplitude of an amplified voltage at the second input to the DD-MZM;
a second DC bias voltage source connected to a fifth input to the DD-MZM, wherein the second DC bias voltage source is configured to increase the amplitude of an amplified voltage at the third input to the DD-MZM; and
an output port of the DD-MZM configured to generate the multiple wavelengths.

13. The multiwavelength EDFL of claim 1, further comprising:
an optical spectrum analyzer (OSA) connected to an output of the fiber coupler, wherein the OSA is configured to monitor a spectrum of the output laser beam.

14. The multiwavelength EDFL of claim 13, further comprising:
an optical power meter (OPM) connected to an output of the fiber coupler, wherein the OPM is configured to monitor a lasing power of the output laser beam.

15. A method for generating multiple wavelengths by a single ring cavity erbium-doped fiber laser (EDFL), comprising:
injecting a pump laser beam into a single ring cavity through a WDM coupler;
generating an amplified laser beam by amplifying, by stimulated emission of an erbium doped fiber located in the single ring cavity, the pump laser beam;
isolating, with an optical isolator (ISO) connected to an output of the erbium doped fiber, the amplified laser beam from back reflections in the single ring cavity;
dividing, by a fiber coupler located in the single ring cavity and connected to the ISO, the amplified laser beam into an output laser beam and a laser beam retained in the single ring cavity;
filtering, with a tunable optical filter (TOF) located within the single ring cavity and connected at a TOF input to the fiber coupler and at a TOF output to the input of the WDM coupler, the retained laser beam to a desired wavelength selected from the range of 1524 nm to 1650 nm; and
dividing, by an out of cavity comb filter (CF) connected to the fiber coupler, the output laser beam into multiple wavelengths.

16. The method of claim 15, further comprising:
configuring the erbium doped fiber to have an ion concentration of about 16×10²⁴ ions per meter cubed, and a length of about 5 meters.

17. The method of claim 15, further comprising:
dividing the output laser beam into about 49 wavelengths by varying a frequency of an alternating voltage input to the DD-MZM.

18. The method of claim 15, further comprising:
receiving the output laser beam at a first input to the DD-MZM of the out of cavity CF;
generating, by a frequency variable voltage source, a sinusoidal voltage;
amplifying, by a first converter amplifier connected to the frequency variable voltage source, the sinusoidal voltage;
inputting the sinusoidal voltage from the first converter amplifier to a second input to the DD-MZM;
amplifying, by a second converter amplifier connected to the frequency variable voltage source, the sinusoidal voltage;
inputting the sinusoidal voltage from the second converter amplifier to a third input to the DD-MZM;
receiving, at a fourth input to the DD-MZM, a first DC bias voltage, wherein the first DC bias voltage is configured to increase the amplitude of the amplified sinusoidal voltage at the second input to the DD-MZM;
receiving, at a fifth input to the DD-MZM, a second DC bias voltage, wherein the second DC bias voltage is configured to increase the amplitude of the amplified sinusoidal voltage at the third input to the DD-MZM; and
generating, at an output port of the DD-MZM, the multiple wavelengths.

19. The method of claim 15, further comprising:
monitoring, with an optical spectrum analyzer (OSA) connected to an output of the fiber coupler, a spectrum of the output laser beam; and
monitoring, with an optical power meter (OPM) connected to the output of the fiber coupler, a lasing power of the output laser beam.

20. A method of assembling a multiwavelength erbium-doped fiber laser (EDFL) having a single ring cavity, comprising:
connecting a wave division multiplexer (WDM) coupler into the single ring cavity;
connecting a pump laser located extra-cavity to the WDM coupler, wherein the pump laser is configured to inject a pump laser beam into the single ring cavity through the WDM coupler;
connecting an input of an erbium doped fiber to the WDM coupler, wherein the erbium doped fiber is configured to amplify the pump laser beam and generate an amplified laser beam at an output of the erbium doped fiber, wherein the erbium doped fiber is configured to have an ion concentration of about 16×10²⁴ ions per meter cubed and a length of about 5 meters;
connecting an optical isolator (ISO) to the output of the erbium doped fiber;
connecting a fiber coupler to the ISO, wherein the fiber coupler is configured to divide the amplified laser beam into an output laser beam and a laser beam retained in the single ring cavity;
connecting an input of a tunable optical filter (TOF) to the fiber coupler and an output of the TOF to the input of the WDM coupler, wherein the TOF is configured to receive the laser beam retained in the single ring cavity and filter the laser beam retained in the single ring cavity to a desired wavelength selected from the range of 1524 nm to 1650 nm; and
connecting an out of cavity comb filter (CF) to the fiber coupler, wherein the out of cavity CF includes a dual-drive Mach-Zehnder modulator (DD-MZM) configured to receive the output laser beam and divide the output laser beam into multiple wavelengths.
